(19) United States
(12) Patent Application Publication
(10) Pub. No.: US 2002/0091601 A1
(43) Pub. Date: Jul. 11, 2002

(54) Revolving credit method of charging for telecommunication services

(76) Inventors: Paul James Fellingham, Holmdel, NJ (US); Tung-Hai Hsiao, Holmdel, NJ (US); Blake Lane Wattenbarger, Fair Haven, NJ (US)

Correspondence Address: KENYON & KENYON, Suite 700, 1500 K Street, N.W., Washington, DC, 20005, US

(21) Appl. No.: 09/755,692

(22) Filed: Jan. 5, 2001

(51) Int. Cl. G06F 17/60

(52) U.S. Cl. 705/34

(57) ABSTRACT

The present invention provides a revolving credit method for charging customers for telecommunications services. According to one embodiment, a customer is provided with an initial credit limit, which is debited as the customer utilizes telecommunications services. The customer is not required to pay for used telecommunications services until the credit limit reaches zero. Once the limit reaches zero, the telecommunication's service provider will charge the initial credit limit amount on the customer's credit card and inform the customer that the credit is zero. If the customer wants to continue with the service, the service provider may initiate another round of credit. According to one embodiment, in order to clear pending balances, a time limit is associated with the credit.

### FIELD OF THE INVENTION

The present invention relates generally to telecommunication systems. In particular, the present invention is directed to a method and system of charging for telecommunication services.

### BACKGROUND OF THE INVENTION

Known methods for charging customers for telecommunications include a pre-paid and post-charge method. The pre-paid method requires a customer to pay fees before services are used. With the post-charge method, customers are charged after the service is used. The post-charge method is the most common method with residential and calling card services.

However, with known methods, telecommunications providers face the disadvantages of billing very small amounts on credit cards that may be less than the transaction cost itself. On the other hand, customers may run up significant charges for telecommunications services and later fail to pay. In addition, with known methods, the service provider is required to wait another month to realize that the customer is not able to pay the bill.

### SUMMARY OF THE INVENTION

The present invention provides a revolving credit method for charging customers for telecommunications services. The present invention includes elements of a pre-paid and post-charge method. According to one embodiment, billing is post-paid dollar-threshold driven (rather than monthly billed). In another embodiment, the initial monthly credit is pre-paid, with any excess usage for the month being post-paid. According to one embodiment, a customer is provided with an initial credit limit, which is debited as the customer utilizes telecommunications services. The customer is not required to pay for used telecommunications services until the credit is expended. Once the credit is expended, the telecommunication's service provider will charge the initial credit limit amount on the customer's credit card and inform the customer that their credit is zero. If the customer wants to continue with the service, the service provider may initiate another round of credit. According to one embodiment, in order to clear pending balances, a time limit is associated with the credit. The time limit is used to clear any pending balances. This prevents customers from avoiding payment by sparingly using the system.

According to one embodiment, a gateway switch provides prompting and collects a customer's account number and a PIN (“Personal Identifier Number”) when a customer dials into the gateway switch. According to an alternative embodiment, a customer's calling line number (Automatic Number Identification) may be sufficient to identify the caller. After verification and authentication, the gateway switch receives a destination phone number with which the gateway switch establishes a connection. The gateway switch monitors customer use and deducts credit as the customer utilizes telecommunications services. When the credit is expended, the customer is charged for the credit used. Additionally, the customer may be prompted to elect to continue with another round of credit. If the customer responds with an affirmative response, a new initial credit limit is established. Otherwise, the telecommunications service (e.g., the call) can be terminated.

According to another embodiment, the revolving credit method allows the service provider to adjust the credit amount and the time period based on the customer's usage pattern in order to give, for example, high-end customers more incentive to use the service. In addition, the invention allows simultaneous calls to be charged to the same credit card, unlike the pre-paid method which inherently does not provide this incentive.

### BRIEF DESCRIPTION OF THE DRAWINGS

FIG. 1 is a block diagram of a telecommunications network architecture that incorporates a charging system for telecommunications services.

FIG. 2 is a block diagram of a VoIP gateway according to one embodiment of the present invention.

FIG. 3 is a flowchart that depicts a set of steps for a call setup process according to one embodiment of the present invention.

FIG. 4 is a flowchart depicting a set of steps for billing a call using a revolving credit method according to one embodiment of the present invention.

FIG. 5 is a flowchart that depicts a set of steps for monitoring usage on a call in progress according to one embodiment of the present invention.

### DETAILED DESCRIPTION

The present invention provides a method and system for charging of customers for telecommunication services. The embodiments described herein are merely illustrative and are not intended to limit the scope of the claims appended hereto. The present invention is applicable to any environment for charging a customer for the use of a telecommunication system. Although the embodiments described herein pertain to charging for VoIP services, the present invention is applicable to charging for any type of telecommunications service.

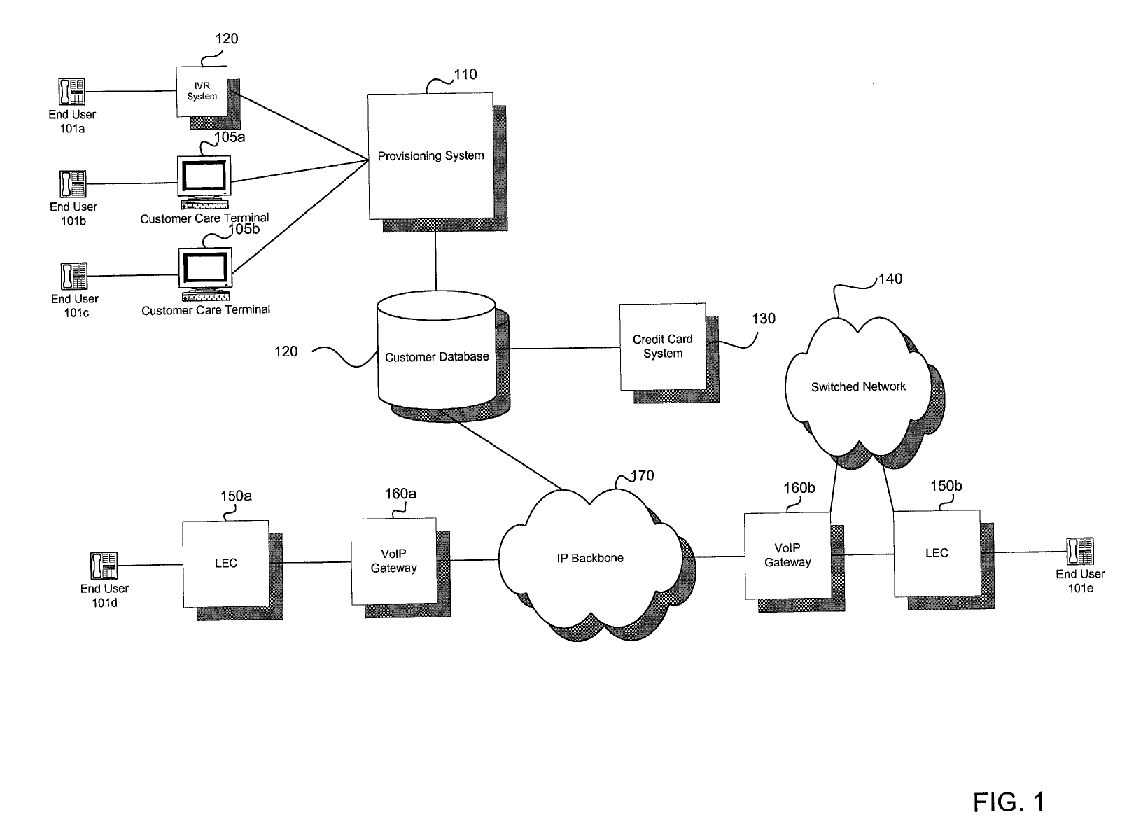

FIG. 1 is a block diagram of a telecommunications network architecture that incorporates a charging system for telecommunications services according to one embodiment of the present invention. End user 101d communicates with end user 101e via LEC (“Local Exchange Carrier”) 150a, VoIP gateway 160a, IP backbone 170, VoIP gateway 160b and LEC 150b. The telecommunications network also includes customer database 120, which may be remote from VoIP gateways 160a and 160b and credit card system 130 for automatically processing credit card transactions. End user PC 101b and customer care terminal 105 communicate directly with provisioning system 110 while end user 101a communicates with provisioning system 110 via IVR (“Interactive Voice Response”) system 120. Provisioning system 110 performs establishment of customer accounts and interacts directly with customer database 120.

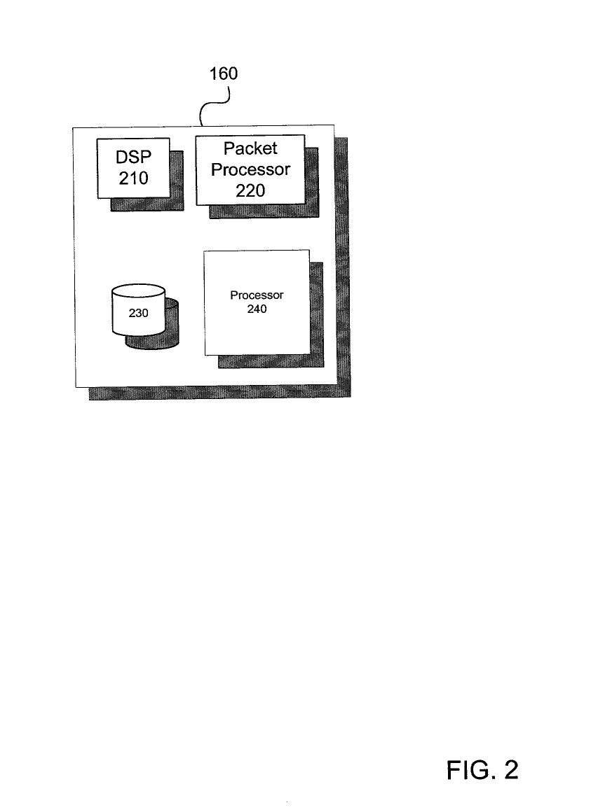

FIG. 2 is a block diagram of a VoIP gateway according to one embodiment of the present invention. VoIP gateway 160 includes DSP (“Digital Signal Processor”), packet processor 220, permanent storage device 230 and processor 240. According to alternative embodiments, DSP and packet processor functions may be implemented on processor 240 rather than existing as separate functional blocks. Processor 240, among other things, performs charging for VoIP calls arriving at VoIP gateway 160a.

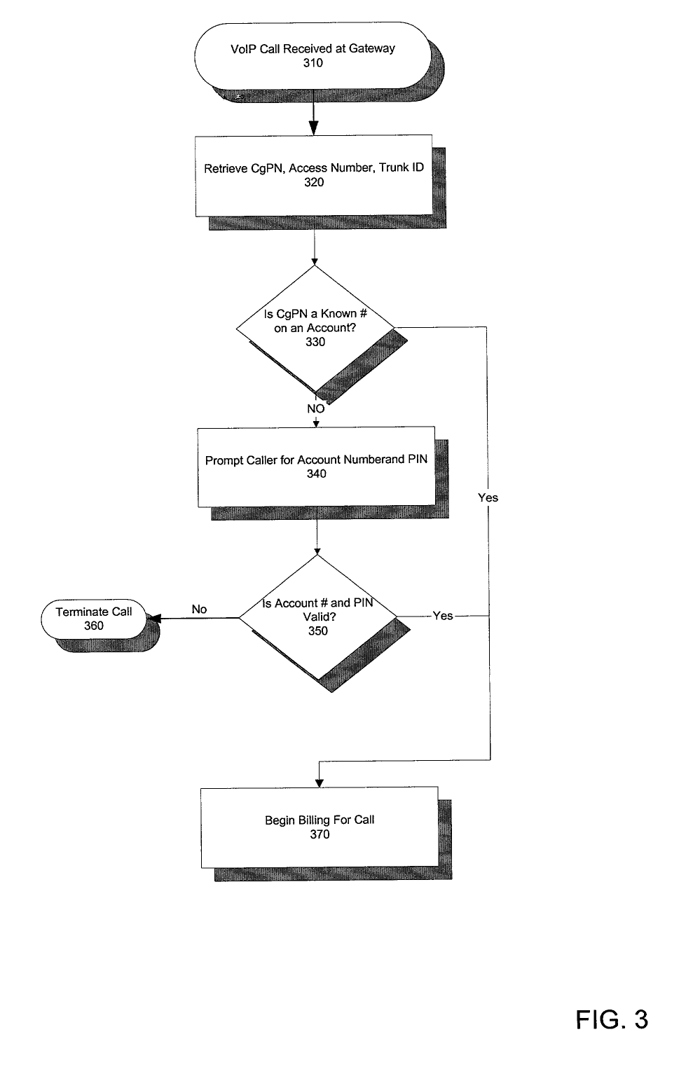

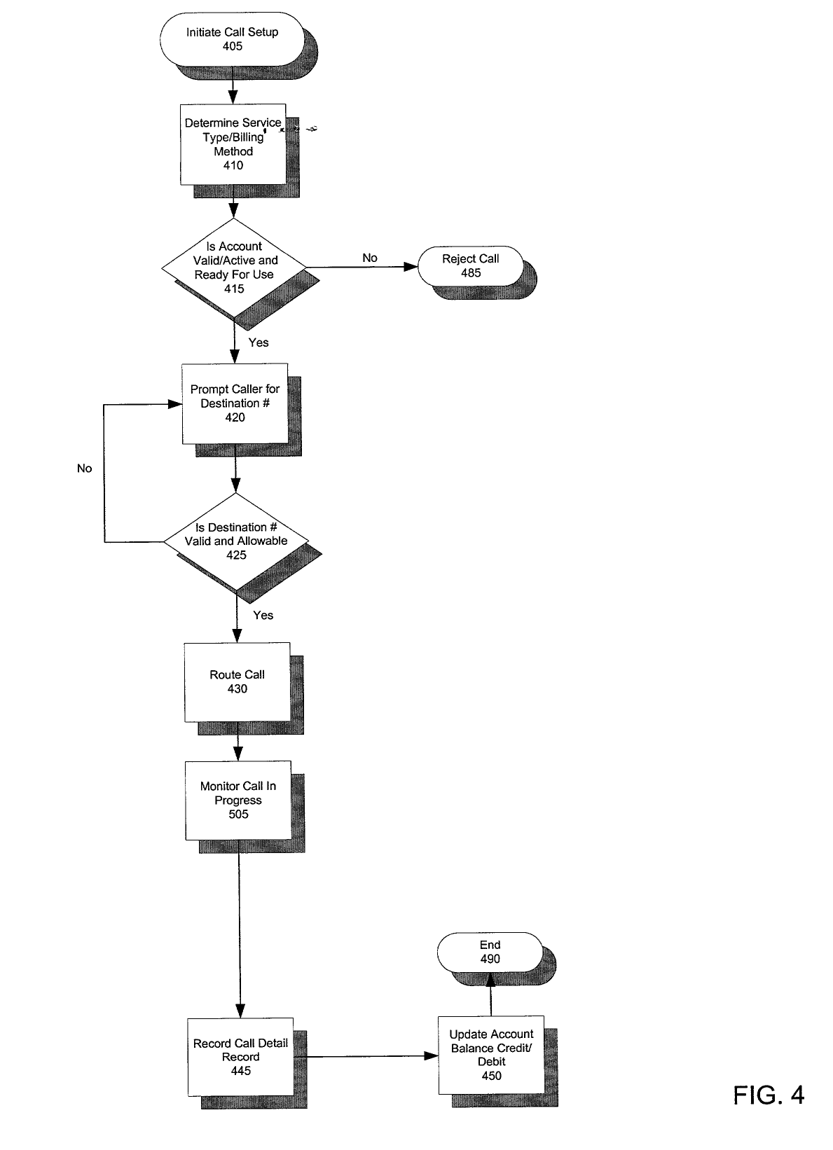

FIG. 3 is a flowchart that depicts a set of steps for a call setup process according to one embodiment of the present invention. According to one embodiment, this process is executed at a telecommunications node such as VoIP gateway 160a. In step 310, the VoIP call is received at the gateway. In step 320, the calling party's number (“CgPN”) is retrieved. The automatic retrieval of the CgPN allows customers who commonly call into the system from the same phone line to avoid entering their account number and PIN each time the communication system is used from that line. Typically an ANI (“Automatic Number Identifier”) is transmitted as part of a call setup process. In step 330, it is determined whether the CgPN is a known number of an account established to access VoIP services. If the number is a known number (‘yes’ branch of step 330), the customer recording system is initiated to start a recording process for the call (see FIG. 4).

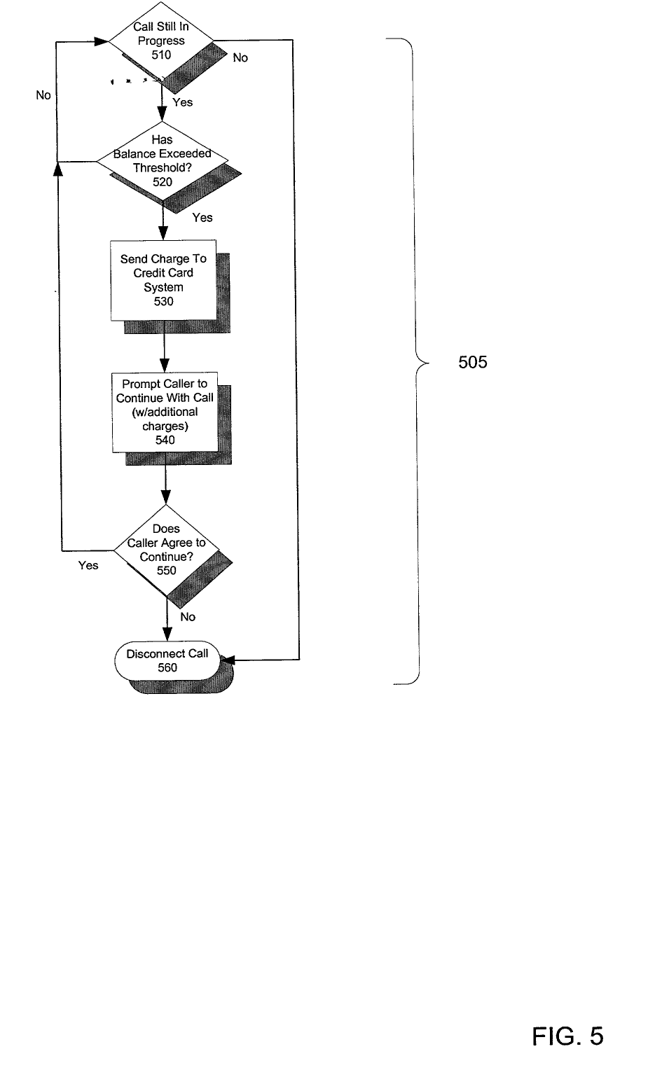

If the CgPN is not a known number on the system (‘no’ branch of step 330), the gateway prompts the caller for an account number and PIN (“Personal Identification Number”) in step 340. The gateway then attempts to validate the account number and PIN in step 350 to ensure whether the account number represents an account in the system and that the PIN is the proper PIN for that account number. If it is determined that the account number and/or PIN are/is invalid (‘no’ branch of step 350), the call is terminated (step 360). According to an alternative embodiment, the gateway may re-request account information a number of times from the caller. If the account number and PIN number are valid (‘yes’ branch of step 350), recording is initiated in step 370 (see FIGS. 4-5).

Each user of the system is provided with a pre-defined or initial credit limit or threshold for utilizing telecommunication services. This amount may vary depending on a customer's usage and credit rating. After a call has been made using the revolving credit system, the cost of the call will be added to his balance, reducing his available credit. Thus, each customer is associated with a balance value that reflects the current amount of telecommunications services that have been utilized.

FIG. 4 is a flowchart depicting a set of steps for billing a call using a revolving credit method according to one embodiment of the present invention. Initially, the system determines whether the account utilizes the revolving credit method in step 410 and what type of call service the caller desires to use (e.g., VoIP, POTS, etc.). In step 415, it is determined whether the account is valid and ready for use (e.g., credit limit has not been reached). If the credit limit in the account has not reached a threshold amount and the account is active and ready for use (‘yes’ branch of step 415), the caller is prompted for the destination number in step 420. Otherwise, if the account is not valid/active (‘no’ branch of step 415), the call is rejected in step 485.

In step 420, the caller is prompted for a destination number. In step 425 the destination number is screened to make sure it is valid. If the destination is determined to be valid (‘yes’ branch of 425), the call is routed in step 430 and monitoring of the call in progress is performed in process 505 (see FIG. 5). If the destination number is not valid and allowable (‘no’ branch of 425) the caller is again prompted for the destination phone number in step 420. Alternatively, the call may be disconnected.

After the call has ended, a call detail record is recorded in step 445 and the customer's account balance is updated in step 450. The process ends in step 490.

FIG. 5 is a flowchart that depicts a set of steps for monitoring usage on a call in progress according to one embodiment of the present invention. In particular, process 505 pertains to the monitoring of a call in progress. In step 510, the balance is constantly updated by the usage accrued and it is determined whether the call is still in progress (i.e., the customer has not disconnected). If the customer has disconnected (‘no’ branch of step 510), the call is disconnected in step 560 and flow returns to step 445 (see FIG. 4). In step 520, it is determined whether the balance on the account exceeds the credit limit or threshold value. If not (‘no’ branch of step 520), it is determined whether the call usage monitoring continues in step 510. If the account balance has exceeded the threshold value (‘yes’ branch of step 520), the account charge is sent to the credit card system in step 530. In step 540, the caller is prompted as to whether he or she desires to continue with the call with additional charges. According to an alternative embodiment, the account could be provisioned to automatically accept additional charges and thereby not prompt the caller. In step 550, it is determined whether the caller agrees to continue with the call. If not (‘no’ branch of step 550), the call is disconnected in step 560 and flow returns to step 445 (See FIG. 4). If so (‘yes’ branch of step 550), call monitoring continues with step 510.

According to an alternative embodiment, a time limit rather than tracking of a customer balance reaching a credit limit is employed. This feature ensures that a telecommunication service provider does not have to wait for an unreasonable amount of time before receiving payment. For example, if a customer has used $30 of service in the first month and no service there after, and the initial credit limit is greater then $30, the customer's credit card will be charged with the $30 to clear the pending balance when the time limit is hit.

What is claimed is

1. A method of charging for telecommunication services comprising the steps of:
storing a balance value and a threshold value relating to at least one customer;
monitoring a call usage pertaining to the at least one customer;
updating the balance value pertaining to a customer based upon the call usage of the customer;
if the balance value one of falls below the threshold value and exceeds the threshold value, executing the steps of:
billing the customer for the call usage.

2. The method according to claim 1, further including the steps of:
prompting the customer for authorization to accept an additional credit value; and,
updating the balance value to reflect the additional credit value.

3. The method according to claim 1, further including the steps of:
updating the balance value to reflect a predefined additional credit value.

4. The method according to claim 1, further including the steps of:
if the customer has not been billed at least once during a time period, executing the steps of:
billing the customer for the call usage; and,
updating the balance value to reflect the call usage.

5. The method according to claim 1, further including the step of adjusting the threshold value based upon a previous usage pattern.

6. The method according to claim 1, further including the step of terminating the call usage and inactivating an account of the customer.

7. The method according to claim 1, wherein the customer is billed an amount equal to the threshold value prior to the call usage.

8. The method according to claim 1, wherein the customer is associated with an account number and PIN (“Personal Identification Number”),

9. The method according to claim 1, wherein the customer is automatically identified by an identity of an associated telephone line.

10. A system for charging for telecommunications services comprising:
at least one telecommunications node for receiving a call, wherein each of the at least one telecommunications nodes includes:
a processor, wherein the processor is adapted to:
store a balance value and a threshold value pertaining to at least one customer;
monitor a call usage pertaining to the at least one customer;
update the balance value based upon the call usage;
if the balance value one of falls below the threshold value and exceeds the threshold value, execute the step of:
bill the customer for the call usage.

11. The system according to claim 10, wherein the processor is further adapted to:
prompt the customer for authorization to accept an additional credit value; and,
update the balance value to reflect the additional credit value.

12. The system according to claim 10, wherein the processor is further adapted to update the balance value to reflect a predefined credit value.

13. The system according to claim 10, wherein the processor is further adapted to if the customer has not been billed at least once during a time period:
bill the customer for the call usage; and,
update the balance value to reflect the call usage.

14. The system according to claim 10, wherein the processor is further adapted to adjust the threshold value based on a previous usage pattern.

15. The system according to claim 10, wherein the processor is further adapted to terminate the call usage for the customer and deactivate an account associated with the customer.

16. The system according to claim 10, wherein the processor is further adapted to authenticate the customer based upon an account number and PIN associated with the customer.

17. The system according to claim 10, wherein the processor is further adapted to authenticate the customer based upon an identity of a telephone line associated with the customer.
